(19) United States
(12) Patent Application Publication
(10) Pub. No.: US 2005/0034581 A1
(43) Pub. Date: Feb. 17, 2005

(54) Method and apparatus for cutting a curly puff extrudate

(76) Inventors: Eugenio Bortone, Frisco, TX (US); Phillip Stuart Fraizer, Frisco, TX (US); Jorge C. Morales-Alvarez, Plano, TX (US); Daniel Eugene Orr, Addison, TX (US); Michael Charles Ruiz, Irving, TX (US); James L. Sanford, Kemp, TX (US)

Correspondence Address: CARSTENS YEE & CAHOON, LLP, P O BOX 802334, DALLAS, TX, 75380, US

(21) Appl. No.: 10/639,172

(22) Filed: Aug. 12, 2003

(51) Int. Cl. B26D 1/00

(52) U.S. Cl. 83/469

(57) ABSTRACT

A method and apparatus for cutting a puff extrudate utilizing a first bladed roll and a second bladed roll. The first and second bladed rolls rotate in opposite directions, and work together to cut the extrudate into similarly sized pieces. The blades are positioned on the rolls offset to each other so as to cut the extrudate with a shearing action.

### BACKGROUND OF THE INVENTION

1. Technical Field

The present invention relates generally to the production of a puff extrudate and, specifically, to a method and apparatus for producing a plurality of similarly shaped curly puff extrudate pieces from a single curly puff extrudate.

2. Description of Related Art

The production in the prior art of a puff extruded product, such as snacks produced and marketed under the Cheetos™ brand label, typically involves extruding a corn meal or other dough through a die having a small orifice at extremely high pressure. The dough flashes or puffs as it exits the small orifice, thereby forming a puff extrudate. The typical ingredients for the starting dough may be, for example, corn meal of 41 pounds per cubic foot bulk density and 12 to 13.5% water content by weight. However, the starting dough can be based primarily on wheat flour, rice flour, soy isolate, soy concentrates, any other cereal flours, protein flour, or fortified flour, along with additives that might include lecithin, oil, salt, sugar, vitamin mix, soluble fibers, and insoluble fibers. The mix typically comprises a particle size of 100 to 1200 microns.

The puff extrusion process is illustrated in FIG. 1, which is a schematic cross-section of a die 12 having a small diameter exit orifice 14. In manufacturing a corn-based puff product, corn meal is added to, typically, a single (i.e., American Extrusion, Wenger, Maddox) or twin (i.e., Wenger, Clextral, Buhler) screw-type extruder such as a model X25 manufactured by Wenger or BC45 manufactured by Clextral of the United States and France, respectively. Using a Cheetos™ like example, water is added to the corn meal while in the extruder, which is operated at a screw speed of 100 to 1000 RPM, in order to bring the overall water content of the meal up to 15% to 18%. The meal becomes a viscous melt 10 as it approaches the die 12 and is then forced through a very small opening or orifice 14 in the die 12. The diameter of the orifice 14 typically ranges between 2.0 mm and 12.0 mm for a corn meal formulation at conventional moisture content, throughput rate, and desired extrudate rod diameter or shape. However, the orifice diameter might be substantially smaller or larger for other types of extrudate materials.

While inside this orifice 14, the viscous melt 10 is subjected to high pressure and temperature, such as 600 to 3000 psi and approximately 400° F. Consequently, while inside the orifice 14, the viscous melt 10 exhibits a plastic melt phenomenon wherein the fluidity of the melt 10 increases as it flows through the die 12. The extrudate 16 exits an orifice 14 in the die 12. The cross-sectional diameter of the orifice 14 is dependent on the specific dough formulation, throughput rate, and desired rod (or other shape) diameter, but is preferred in the range of 1 mm to 14 mm. (The orifice 14 diameter is also dependent on the mean particle size of the corn meal or formula mix being extruded.)

It can be seen that as the extrudate 16 exits the orifice 14, it rapidly expands, cools, and very quickly goes from the plastic melt stage to a glass transition stage, becoming a relatively rigid structure, referred to as a “rod” shape, if cylindrical, puff extrudate. This rigid rod structure can then be cut into individual pieces, and further cooked by, for example, frying, and seasoned as required.

Any number of individual dies 12 can be combined on an extruder face in order to maximize the total throughput on any one extruder. For example, when using the twin screw extruder and corn meal formulation described above, a typical throughput for a twin extruder having multiple dies is 2,200 lbs., a relatively high volume production of extrudate per hour, although higher throughput rates can be achieved by both single and twin screw extruders. At this throughput rate, the velocity of the extrudate as it exits the die 12 is typically in the range of 1000 to 4000 feet per minute, but is dependent on the extruder throughput, screw speed, orifice diameter, number of orifices and pressure profile.

As can be seen from FIG. 1, the snack food product produced by such process is necessarily a linear extrusion which, even when cut, results in a linear product. Consumer studies have indicated that a product having a similar texture and flavor presented in a “curl,” “spiral,” or “coil spring” shape (all of which terms are used synonymously by Applicant herein) would be desirable. An example of such spiral shape of such extrudate is illustrated in FIG. 2, which is a perspective view of one embodiment of a spiral or curl shaped puff extrudate 20.

The apparatus for making curly puff extrudate is the subject matter of U.S. patent application Ser. No. 09/952,574 entitled “Apparatus and Method for Producing a Curly Puff Extrudate” and is incorporated herein by reference. Generally, however, some type of containment vessel such as a pipe or tube (terms used synonymously by the Applicant herein) positioned at the exit end of an extruder die face is used to produce a curly puff extrudate. However, it has been difficult to cut a curly puff extrudate into individual extrudate pieces, where the cut is consistent, (meaning that complete separation is achieved), where the individual extrudate pieces cut are of a controlled length, and where the individual extrudate pieces cut have smooth ends. For example, FIG. 3 illustrates a perspective view of a device where the extrudate is cut at the end of the tube, which may result in jagged ends.

Referring now to FIG. 3, a number of tubes 30 are shown attached to a die face 18. The exit end of each tube 30 is attached to an extruder face 23. A circular cutting apparatus 24 having a number of individual cutting blades 26 is attached to the extruder face 23. A curly puff extrudate is formed within the tubes 30, exits through the exit ends of the tubes 30, and is cut by the cutting blades 26 into smaller individual extrudate pieces.

Cutting the curly puff extrudate 20 at the end of the tube 30 in a multiple tube assembly is not preferred because the cutting blades 26 drag the curly puff extrudate from one tube 30 to another. This dragging can result in jagged ends on the cut individual curly puff extrudate pieces. FIG. 4 is an example of an individual piece of curly puff extrudate 35 cut with a device similar to the one in FIG. 3, and having jagged ends. Additionally, when the curly puff extrudate 20 is produced in a multiple tube assembly, the tubes may not produce extrudate at the same rate, so a single cutter cutting multiple tubes will produce individual extrudate pieces of differing lengths. In the case of a curly puff extrudate, the differing lengths can result in differing numbers of coils in each individual piece.

Thus, providing a consistent cut of a curly puff extrudate as it exits a forming tube that does not result in individual cut extrudate pieces with jagged ends and/or an uncontrolled length has been a problem. It may be that as the curly puff extrudate exits the forming tube, it is predominantly characterized by its plastic melt stage as opposed to its glass transition stage. When predominantly characterized by its plastic melt stage, the curly puff extrudate may be too soft to allow for a consistent cut (meaning complete separation of the individual piece of extrudate). Further downstream from the forming tube, the curly puff extrudate becomes more characterized by its glass transition stage, and gains surface rigidity as it continues to cool and dry. Such surface rigidity may allow for more consistent cutting.

Accordingly, a need exists for an apparatus and method for cutting a curly puff extrudate downstream from the forming tube, where cuts can be made more consistently. A need also exists for an apparatus and method of cutting a curly puff extrudate into individual curly puff extrudate pieces that provides smooth cuts at each end of the individual pieces. Moreover, a need exists for an apparatus and method of controlling the length of individually cut pieces of a curly puff extrudate. In the case of a curly puff extrudate, controlling the length of the individually cut piece of extrudate also results in controlling the number of coils in each individual piece. It should be understood, however, that these needs are not limited to a curly puff extrudate. A need also exists for an apparatus for cutting a sinusoidal puff extrudate as well as other types of linear and non-linear puffed extrudates.

The present invention provides devices and methods to meet these needs. The devices and methods can be incorporated into a production system for curly puff extrudates and other puffed extrudates.

### SUMMARY OF THE INVENTION

The present invention comprises a cutting assembly for cutting an extrudate. According to one embodiment, the cutting assembly comprises a first roll disposed in a plane and rotatably mounted on a frame, and a second roll disposed in the same plane and adjacent to the first roll. The second roll is also rotatably mounted on the frame, and rotates in a direction opposite the direction of rotation of the first roll. Each roll has one or more blades mounted along its length. The blades on the first roll are in an offset position with respect to the blades on the second roll so that as each blade on the first roll rotates past a corresponding blade on the second roll, a blade gap is created between the blade on the first roll and its corresponding blade on the second roll. The cutting assembly cuts extrudate fed to it as the extrudate enters the blade gap with a shearing-type cutting action because of the offset mounting of the blades.

According to another embodiment, the cutting assembly comprises a first wheel disposed in a plane and rotatably mounted on a first shaft, and a second wheel disposed in the same plane and adjacent to the first wheel. The second wheel is rotatably mounted on a second shaft. Each of the first wheel and the second wheel has an inwardly curved peripheral surface. Because the first and second wheels are disposed adjacent to each other in the same plane, a saddle is formed between the peripheral surface of the first wheel and the peripheral surface of the second wheel. Each of the first and second wheels has one or more wheel blades mounted orthogonally thereto. The blades on the first wheel are mounted in an offset position with respect to the blades on the second wheel so that as each blade on the first wheel rotates past a corresponding blade on the second wheel, a blade gap is created between the blade on the first wheel and its corresponding blade on the second wheel. Extrudate is fed to the cutting assembly through the saddle. As the extrudate enters the blade gap, the blades cut the extrudate with a shearing-type cutting action because of the offset mounting of the blades.

The present invention further comprises methods for cutting an extrudate. The methods herein result in cutting of an extrudate into individual pieces of extrudate with a shearing. type cutting action by contacting the extrudate with blades in an offset position. The shape and length of the individual pieces of extrudate cut according to the methods herein can be controlled by various operational adjustments.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a schematic cross-section of a prior art puff extrudate die;

FIG. 2 is a perspective view of a length of curly puff extrudate product;

FIG. 3 is a side perspective view of a puff extrudate face cutter applied to a multiple tube assembly for forming curly puff extrudate;

FIG. 4 is a perspective view of a piece of curly puff extrudate cut using the puff extrudate face cutter illustrated in FIG. 3;

FIG. 5 is a side perspective view of a preferred embodiment of a cutting assembly according to the present invention, where continuous blades are mounted on rolls.

FIG. 6 is a partial plan view of the cutting assembly illustrated in FIG. 5;

FIG. 7 is a perspective view of the first roll of the cutting assembly illustrated in FIG. 5.

FIG. 8 is a side perspective view of a production system for curly puff extrudate employing the cutting assembly illustrated in FIG. 5;

FIG. 9 is a perspective view of a piece of curly puff extrudate cut according to the embodiments of the present invention;

FIG. 10 is a side perspective view of another embodiment of the blades of the cutting assembly illustrated in FIG. 5;

FIG. 11 is a side perspective view of another embodiment of a cutting assembly according to the present invention, where wheels are mounted in a horizontal plane;

FIG. 12 is a side perspective view of another embodiment of a cutting assembly according to the present invention, where wheels are mounted in a vertical plane; and

FIG. 13 is a schematic view of an embodiment of a cutting assembly having a bladed wheel and a smooth wheel for cutting.

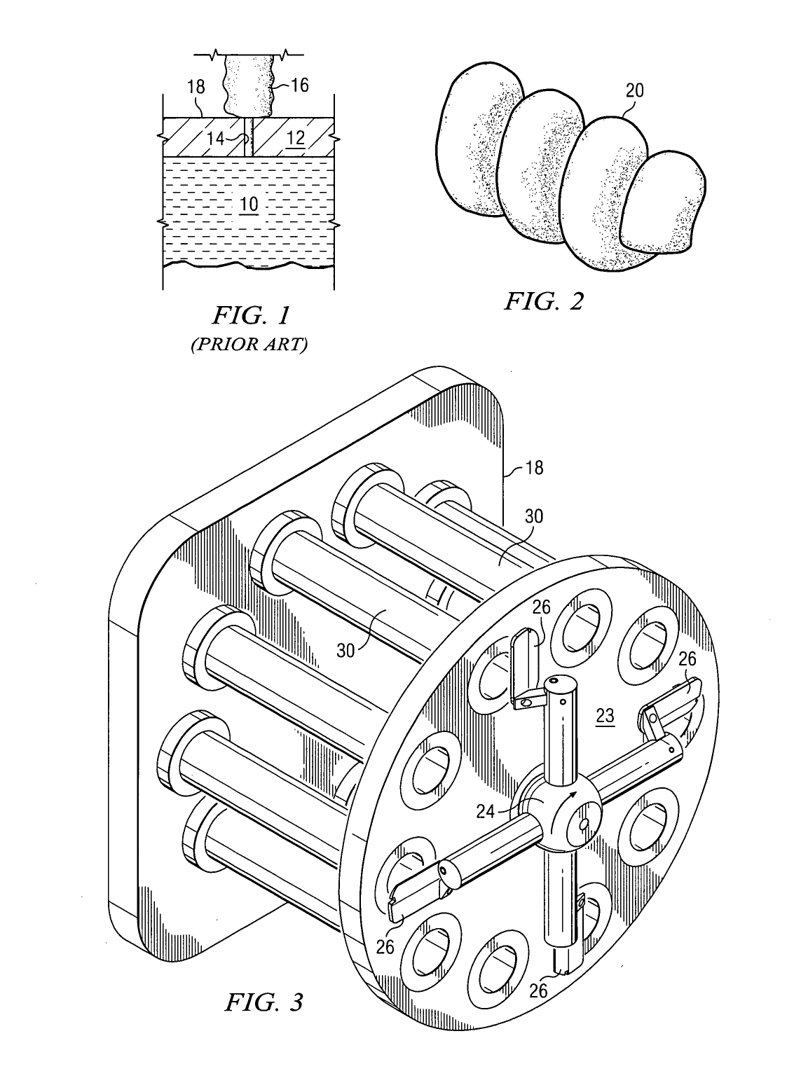

### DETAILED DESCRIPTION

With reference to the accompanying drawings, identical reference numerals will be used to identify identical elements throughout all of the drawings, unless otherwise indicated.

FIG. 5 is a perspective view of a preferred embodiment of a cutting assembly 40 according to the present invention. According to this embodiment, the cutting assembly 40 comprises a first roll 42 and a second roll 44, disposed adjacent to each other in the same plane. According to the embodiment illustrated by FIG. 5, first roll 42 and second roll 44 are disposed in a horizontal plane, however, the rolls could also be disposed in a vertical plane. Preferably, first roll 42 and second roll 44 are cylindrical in shape. Other shapes with acceptable mass moments of inertia in the longitudinal axis, for example rectangular prism or elliptical cylinder, could also be used for the first and second rolls.

First roll 42 and second roll 44 are rotatably mounted, preferably on a frame 50. Although shown in FIG. 5 as a table-style structure, frame 50 can comprise any of a number of structures known in the art as suitable for rotatable mounting of parts such as first and second rolls 42 and 44. A rotation mechanism causes the first and second rolls 42 and 44 to rotate in opposite directions. Preferably, the rotation mechanism comprises a motor (not shown) operably connected to the first roll 42 to drive its rotation, and a gear assembly 43 to transmit rotation to the second roll 44. Thus, first and second rolls 42 and 44 rotate in opposite directions, but at the same speed. According to another embodiment, the second roll 44 is motorized, and transmits rotation to the first roll via the gear assembly 43. Other rotation mechanisms for causing the first and second rolls 42 and 44 to rotate in opposite directions at the same speed are known to those of ordinary skill in the art.

A first plurality of continuous blades 46 is removeably mounted along the length of the first roll 42. As used herein the term “plurality” means one or more. Preferably, if more than one continuous blade is used, each blade in the first plurality of blades is spaced apart from its adjacent blade at a blade spacing distance 52 that is slightly greater than the desired length for the cut extrudate piece. The number of blades mounted on a roll is a function of the diameter (or the radius, defined as one-half of the diameter) of the roll. At a minimum, one blade could be mounted on a roll. At a maximum, the number of blades mounted on a roll is as many as will fit around the perimeter of the roll. For example, if the roll is cylindrical, then the blades are spaced around the perimeter defined as 2πR, where R is the radius of the roll.

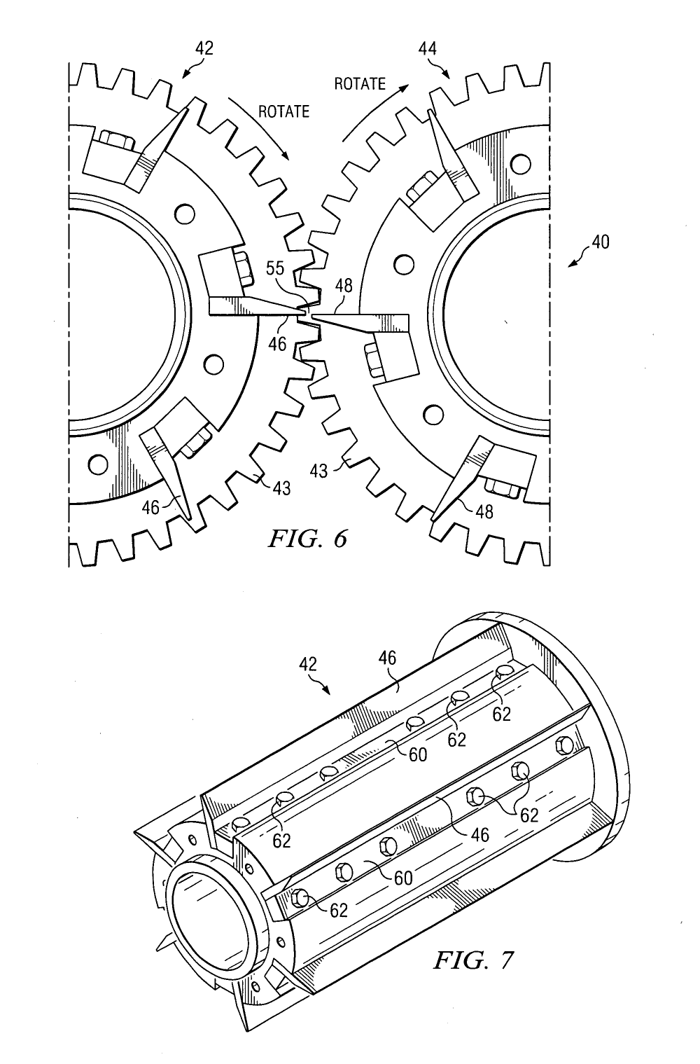

A second plurality of continuous blades 48 is removeably mounted along the length of the second roll 44. As used herein the term “plurality” means one or more. There is a one-to-one correspondence between the number of blades in the second plurality of blades 48 and the number of blades in the first plurality of blades 46. Each blade in the second plurality of blades 48 is spaced apart from its adjacent blade at a blade spacing distance 52 that is equal to the blade spacing 52 in the first plurality of blades. Each of the first and second pluralities of continuous blades 46 and 48 is mounted orthogonal to the roll on which it is mounted. However, the second plurality of continuous blades 48 are mounted on the second roll 44 in what is described herein as an “offset position” or “offset mounting” (terms used synonymously herein by the Applicant) with respect to the first plurality of continuous blades 46. The offset mounting of the blades will be discussed in greater detail herein with respect to FIG. 6.

The diameter of the rolls 42 and 44, the number of blades 46 mounted on the rolls, and the blade spacing distance 52 comprise the “configuration of the cutting assembly”, also referred to as the “cutting assembly configuration”. The cutting assembly configuration is a factor in determining other operating conditions of the cutting assembly, such as the rotation speed for the rolls and the feed speed at which a conveyor provides the extrudate to the cutting assembly.

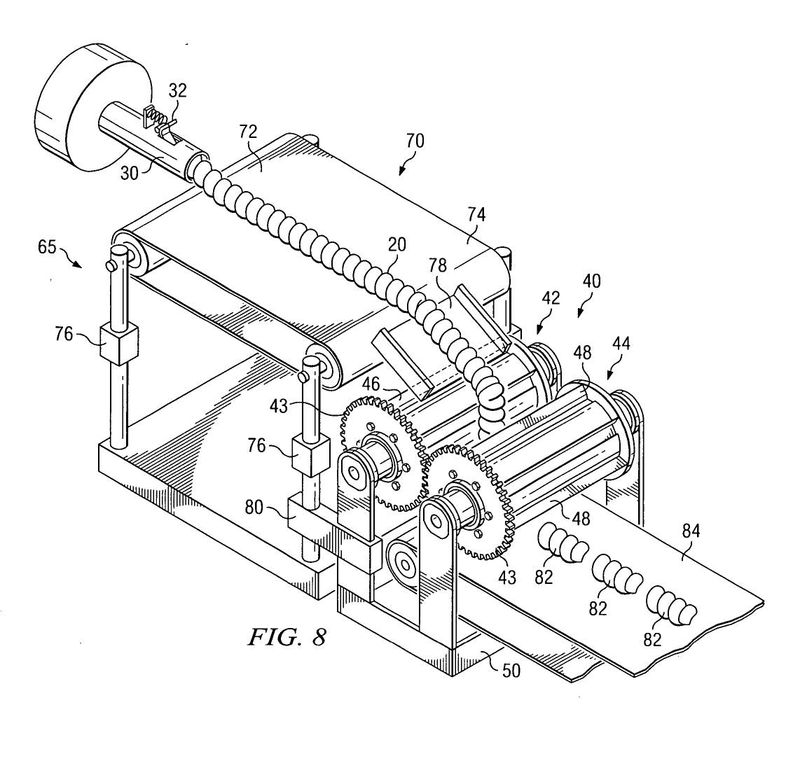

Preferably, the first and second rolls 42 and 44 are driven at a rotation speed that is greater than the feed speed at which the conveyor 70 (FIG. 8) provides the extrudate to be cut. Preferably, the rotation speed of the rolls is at least 1.1 times greater than the feed speed of the conveyor, and more preferably, is in the range from about 1.1 to about 20 times faster than the feed speed of the conveyor. When the rotation speed of the rolls is 1.1 or more times faster than the feed speed, the cutting assembly is referred to herein as operating at a “faster speed differential”. Operating a cutting assembly of a given cutting assembly configuration at a faster speed differential results in the cutting of shorter pieces of individual extrudate than operating a cutting assembly having the same configuration at a rotation speed less than about 1.1 times faster than the feed speed. The greater the rotation speed of the rolls with respect to the feed speed of the conveyor, the shorter the piece of cut extrudate produced on a given cutting assembly configuration.

Longer pieces of extrudate can be cut, however, by a cutting assembly having that same given cutting assembly configuration by changing the rotation speed of the first and second rolls. Operating the first and second rolls 42 and 44 to rotate at a speed equal to or slower than the feed speed of the conveyor 70 results in the cutting of longer pieces of extrudate without the need to change the cutting assembly configuration. Thus, according to another embodiment, the speed of rotation of the first and second rolls 42 and 44 is less than about 1.1 times the feed speed of the conveyor. The cutting assembly according to this embodiment is referred to herein as operating at a “slower speed differential”. When operating at a slower speed differential, the cut pieces of extrudate will be longer than if the speed of rotation of the rolls is greater than about 1.1 times the feed speed of the conveyor operating with a cutting assembly having the same cutting assembly configuration.

According to another method for controlling the length of the cut piece of extrudate, however, the configuration of the cutting assembly, in particular, the blade spacing distance 52 is adjusted. The feed speed of the conveyor 70 can affect the orientation and delivery of the extrudate to the cutting assembly 40, which can affect the ability to cut extrudate pieces of a desired length. Blade spacing distance 52 can be adjusted to respond to the speed of the conveyor to still provide cut extrudate pieces of a desired length. For example, if conveyor 70 is feeding the cutting assembly 40 slower than the first and second rolls 42 and 44 are spinning, short individual pieces of extrudate are produced. To achieve longer individual pieces of extrudate without having to change either the rotation speed or the feed speed, the blade spacing distance 52 is increased.

The distance between each blade has an effect on the length of the individual piece of extrudate cut, and can be adjusted within a wide range for use with any given conveyor speed and rotational speed of the rolls, as well as to achieve individual pieces of extrudate of varying lengths. Accordingly, a wide range of numbers of blades and blade spacing distances is contemplated by the present invention as a way to enable the cutting assembly to be arranged in different configurations to achieve individual cut pieces of extrudate of different lengths and at different rotation and feed speeds.

The rotation speed of the rolls and the feed speed of the conveyor are discussed herein as ratios as opposed to specific values because variables such as the diameter of the rolls, the number of blades on the rolls, and the blade spacing distance, can accommodate a wide range of adjustments, thus making specific values an unwarranted limitation of the present disclosure. By way of example, however, the first and second rolls 42 and 44 are driven at a rotation speed from about 50 RPM (rotations per minute) to about 1000 RPM. Preferred ranges within about 50 RPM to about 1000 RPM are a function of mechanical and operating conditions such as speed of the conveyor supplying extrudate to be cut by the cutting assembly, diameter of the rolls of the cutting assembly, numbers of blades on the rolls, blade spacing distance, driving mechanisms for rotation of the rolls, type and size of conveyor, the amount of meal being pushed through the extruder, and the shape of extrudate being produced.

For example, if the extrudate is a curly puff extrudate, the diameter of the rolls is from about 6 to about 6.5 inches, and the speed of a conveyor is from about 100 FPM (feet per minute) to about 140 FPM, then a preferred range for the rotation speed is from about 110 FPM to about 170 FPM. If the extrudate does not have a circular cross-section area as does the curly puff extrudate, then a preferred rotational speed could be about 300 RPM to about 500 RPM, or could be more or less.

Also by way of example only, specific values for the feed speed of the conveyor are in the range of about 20 FPM to about 750 FPM. Again, the preferred ranges within about 20 FPM to about 750 FPM are a function of mechanical and operating conditions such as diameter of the rolls of the cutting assembly, numbers of blades on the rolls, blade spacing distance, driving mechanisms for rotation of the rolls, type and size of conveyor, the amount of meal being pushed through the extruder, and the shape of extrudate being produced. By way of example, one preferred range for the feed speed is from about 300 FPM to about 500 FPM. Another preferred range for the feed speed is from about 20 FPM to about 140 FPM.

Other preferred ranges for the rotation speed and the feed speed, either within or without the above ranges are possible, depending on the mechanical and operating conditions listed above, such as speed of the conveyor, diameter of the rolls, numbers of blades, blade spacing distance, driving mechanisms, type and size of conveyor, the amount of meal being pushed through the extruder, and the shape of extrudate being produced.

In particular, adjusting the speeds of the first and second rolls 42 and 44 and the conveyor feed speed affects the end shape of the cut piece of extrudate. For example, if the extrudate to be cut is a curly puff extrudate, then the speed of rotation of the first and second rolls 42 and 44, the feed speed of the conveyor 70, and the speed differential between the conveyor 70 and the first and second rolls 42 and 44, are variables that can be adjusted to produce a desired effect on the pitch of the curls in the curly puff extrudate. If the extrudate is a curly puff extrudate, then fast conveyor feed speeds, for example about 70 FPM or more stretch the extrudate out, resulting in a longer pitch for the coils in the extrudate fed to the cutting assembly. Thus, the extrudate has fewer coils in a given length and resembles a worm-like structure. In contrast, slow conveyor feed speeds, for example about 55 FPM or less, result in a shorter pitch for the coils, which translates into more coils in a given length.

Thus, the shape of the extrudate and the length of the cut pieces can be controlled by various operational adjustments. Whether it is desired to cut long pieces of extrudate, or to cut short pieces of extrudate, the appropriate adjustments to the faster or slower speed differentials between the conveyor and the cutting assembly can be made. Likewise, appropriate adjustments to the feed speed of the conveyor can be made to produce an extrudate with a long or a short pitch. Accordingly, a broad range of operating speeds can be used for the rotation of the first and second rolls 42 and 44 and for the feed speed of the conveyor 70, with a collateral effect on the pitch and end shape of a curly puff extrudate, as well as the length of an individually cut piece of extrudate. Similarly, the operating speeds of the first and second rolls 42 and 44, and the conveyor 70, can have collateral effects on the end shape and lengths of extrudates other than curly puff extrudates, such as sinusoidal extrudates or extrudates with a rectangular, triangular, or other non-circular cross-sectional area.

Referring now to FIG. 6, the “offset mounting” of the second plurality of continuous blades 48 with respect to the first plurality of continuous blades 46 is described. Generally, an offset position is any position in which the tips of the second plurality of blades 48 do not contact the tips of the first plurality of blades 46 as they rotate past each other on their respective rolls. Particularly, however, the second plurality of blades 48 and the first plurality of blades 46 are mounted so that as they rotate past each other, a blade gap 55 exists there between. Thus, as each of the first plurality of blades 46 and its corresponding one of the second plurality of blades 48 rotate past each other, they do not make tip-to-tip contact, but rather rotate past each other through the blade gap 55.

Extrudate 20 to be cut is fed to the cutting assembly 40 (FIG. 8) so that it enters into the blade gap 55 orthogonally to the blade gap 55. As the first plurality of blades 46 and second plurality of blades 48 rotate past each other, they orthogonally contact the extrudate in the blade gap 55, and cut it. However, because the first plurality of blades 46 and second plurality of blades 48 are offset with respect to each other, they do not contact each other tip-to-tip. Thus, they exert a shearing-type cutting action, as opposed to a pinching-type cutting action, on extrudate in the blade gap 55.

Blade gap 55 is preferably in the range of about 0 inches to about 0.015 inches. The preferred blade gap depends on a number of factors, one of which is the cross-sectional shape of the extrudate being cut. For example, if the extrudate is a continuous coil, then the preferred blade gap is preferably in the range of about 0 to about 0.003 inches. If the cross-sectional area of the extrudate is not circular, a blade gap greater than 0.003 is preferred. For example, if the extrudate has a rectangular or triangular cross-section, then the blade gap is preferably in the range of 0 inches to 0.015 inches. In addition to the cross-sectional area of the extrudate, factors such as texture, moisture content, and rigidity of the extrudate being cut affect the preferred blade gap. For example, soft extrudates (generally those extrudates with a high moisture content) require less blade gap to be cut. Accordingly, a lower range for blade gap, for example from about 0 inches to about 0.001 inches, is preferred for cutting soft extrudates. For rigid extrudates (generally those extrudates with a low moisture content), a higher range for blade gap, for example from about 0.002 inches to about 0.003 inches, is preferred.

If it is desired to use a blade gap in the higher range, the degree of rigidity of the extrudate can be increased by increasing the length of the conveyor 70 feeding the cutting assembly 40, which gives the extrudate more time to cool before it reaches the cutting assembly, thereby increasing its rigidity. Alternatively, the feed speed of the conveyor could be decreased, which would also give the extrudate more time to cool before reaching the cutting assembly, thereby increasing its rigidity. However, as previously discussed, the feed speed of the conveyor and the speed differential between the conveyor and the rolls of the cutting assembly have collateral effects on the pitch, end shape, and length of the individual pieces of extrudate cut by the cutting assembly.

First plurality of blades 46 and second plurality of blades 48 can be mounted on first roll 42 and second roll 44 respectively by any of several methods known to those of ordinary skill in the art. FIG. 7 is a perspective view of the first roll 42 that illustrates one such method that can be used on both rolls. FIG. 7 shows a wedge 60 disposed in a similarly shaped recess formed in first roll 42. The wedge 60 is positioned within the recess by screws 62, and fills substantially all of the recess, except for a portion left for the insertion of the continuous blade 46. Once the wedge 60 has been positioned, the continuous blade 46 is inserted, and screws 62 are tightened. Other methods for mounting the first plurality of blades 46 and the second plurality of blades 48 are known to those of ordinary skill in the art, and may be employed in the present invention as long as the method permits the offset mounting.

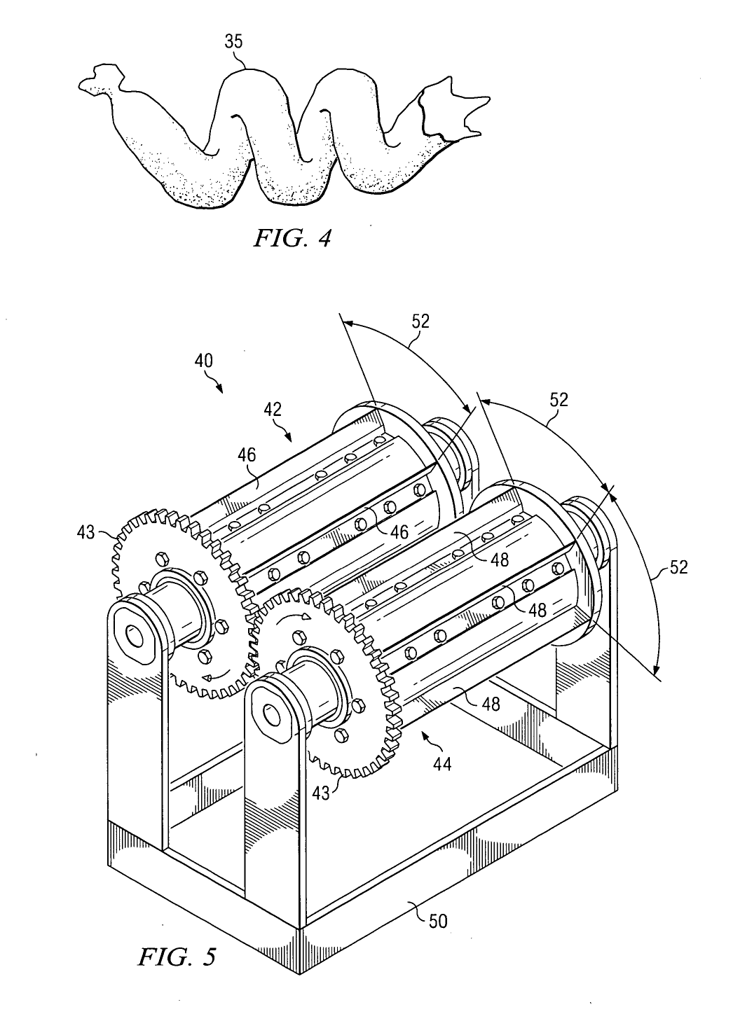

Referring now to FIG. 8, a production system 65 employing the cutting assembly 40 illustrated in FIG. 5 is shown. For simplicity, the details of an extruder assembly, such as the orifice and the die, are not illustrated in FIG. 8, however an extruder assembly as described with reference to FIGS. 1 and 3 provides the extrudate. If a curly puff extrudate 20 is desired, a tube 30 with a flapper 32 can be used. A flapper 32 puts pressure on the extrudate exiting the orifice of the die so that curls will form in the extrudate. For simplicity, only a single tube extruder assembly is illustrated, however a multiple tube assembly, such as that shown in FIG. 3, could also be used.

Production system 65 comprises a conveyor 70 with an input end 72 and an output end 74. Input end 72 is positioned to receive curly puff extrudate 20 as it exits from the tube 30. Output end 74 is positioned to feed the curly puff extrudate 20 to the cutting assembly 40. Preferably, the conveyor 70 comprises a variable speed belt conveyor. Either one or both of the input end 72 and the output end 74 may be height-adjustable. In the embodiment illustrated in FIG. 7, both input end 72 and output end 74 are made height-adjustable by a locking leg mechanism 76, provided at each end 72 and 74. Preferably, locking leg mechanism 76 comprises a squeeze lock collar and leg mechanism. This and other mechanisms for height adjustments are known to those of ordinary skill in the art, and thus will not be discussed or illustrated in further detail herein. Furthermore, although not illustrated, side guides and/or a deflector plate can be provided to the conveyor 70 to assist the delivery of the extrudate 20 off of the conveyor 70 and on to the cutting assembly 40.

The length of the conveyor 70 comprises the distance between the extruder die face 18 and the cutting assembly 40. The longer the distance between the extruder die face 18 and the cutting assembly 40, the more time the curly puff extrudate 20 has to cool, and therefore, the more rigid it will become before arriving at the cutting assembly 40. Preferably, the distance between the extruder die face 18 and the cutting assembly 40, and similarly the length of the conveyor 70, is such that the curly puff extrudate 20 is not entirely rigid (that is, fully within its glass transition stage) or entirely soft (that is, fully within its plastic melt stage). However, as discussed above with respect to the blade gap 55, varied rigidities of the extrudate, which may be caused by varied distances between the cutting assembly 40 and the extruder die face 18, can be accommodated by adjusting the blade gap 55. The rigidity of the extrudate can also be manipulated to increase by increasing the length of the conveyor or by slowing the feed speed of the conveyor. As previously discussed, manipulation of the conveyor feed speed has collateral effects on the shape and length of the extrudate and the performance of the cutting assembly.

The conveyor 70 is driven by a motor (not shown) to provide a continuous feed of the curly puff extrudate 20 to the cutting assembly 40. As previously discussed with reference to the rotation of the first and second rolls 42 and 44, the conveyor 70 preferably feeds the curly puff extrudate 20 at a feed speed that is less than the speed of rotation of the first and second rolls 42 and 44. Again, however, the feed speed of the conveyor 70 could be greater than the rotation speed of the first and second rolls 42 and 44, with the collateral effects on the length of the individual extrudate cut, the end shape of the individual extrudate cut, and the performance of the cutting assembly as previously discussed.

In addition, the feed speed of the conveyor 70 affects the orientation of the extrudate as it is delivered to the cutting assembly. Thus, according to the production system illustrated in FIG. 8, a chute 78 is disposed between the output end 74 of the conveyor 70 and the cutting assembly 40 to assist the delivery of the curly puff extrudate 20 to the cutting assembly 40. Other devices, such as ramps and guides may be used in place of the chute 78. The cutting assembly 40 may also have mechanisms to assist the delivery of the curly puff extrudate. For example, according to one embodiment, the cutting assembly 40 comprises a lever mechanism (not shown) operable to adjust, such as by tilting, raising or lowering, the cutting assembly to receive the curly puff extrudate 20. Alternatively, neither a chute nor a lever mechanism is used, rather, the curly puff extrudate 20 is fed unassisted to the cutting assembly 40. If the extrudate is fed to the cutting assembly unassisted, then it is preferable to adjust the respective heights of the conveyor 70 and the cutting assembly so that the output end 74 of the conveyor is higher than the cutting assembly, causing the extrudate to fall into the cutting assembly under a gravitational pull. Alternatively, the distance between the cutting assembly and the conveyor could be minimized so that the blades of the cutting assembly begin pulling the extrudate into the cutting assembly directly as the extrudate leaves the conveyor.

Referring still to FIG. 8, a docking assembly 80 is preferably attached to the conveyor 70 and the cutting assembly 40 to provide a physical connection there between, thereby improving the safety and stability of the production system 65. However, the production system is operable without the docking assembly. If a docking assembly is used, it can take any of several forms known to those of ordinary skill in the art, and be disposed between the cutting assembly and the conveyor at any position where it will create a physical connection there between. According to one example, the docking assembly 80 comprises a tie rod that is vertically adjustable and a pin/clamp assembly that is horizontally adjustable. Once the cutting assembly 40 and conveyor 70 have been placed at their desired heights and at the desired distance from each other, the pins of the pin/clamp assembly are aligned to a mating hole on the frame 50 of the cutting assembly 40, and the tie rod and the pin/clamp assembly are tightened. For simplicity, these details of docking assembly 80 have not been illustrated in FIG. 8, but one of ordinary skill in the art would understand the foregoing description, and would also be able to adapt other forms of docking assemblies for use with the present invention.

As the curly puff extrudate 20 is delivered to the cutting assembly 40, the first and second pluralities of blades 46 and 48 exert a pulling action on the extrudate 20, which contributes to drawing the extrudate 20 into the blade gap 55. This pulling action provides a positive displacement effect to the individual cut piece and contributes to complete separation of the individual piece from the extrudate coil 20. As the first and second rolls 42 and 44 of the cutting assembly 40 rotate, the first and second pluralities of blades 46 and 48 of each roll are brought together in an offset position. Upon contacting the curly puff extrudate in the blade gap 55, the blades cut it into individual extrudate pieces of a desired length. Once cut, individual curly extrudate pieces 82 fall from the cutting assembly 40 onto a piece conveyor 84. From the piece conveyor 84, the curly extrudate pieces 82 are sent for further processing. Examples of such processing include, but are not limited to, seasoning, baking, frying, and packaging the individual extrudate pieces 82.

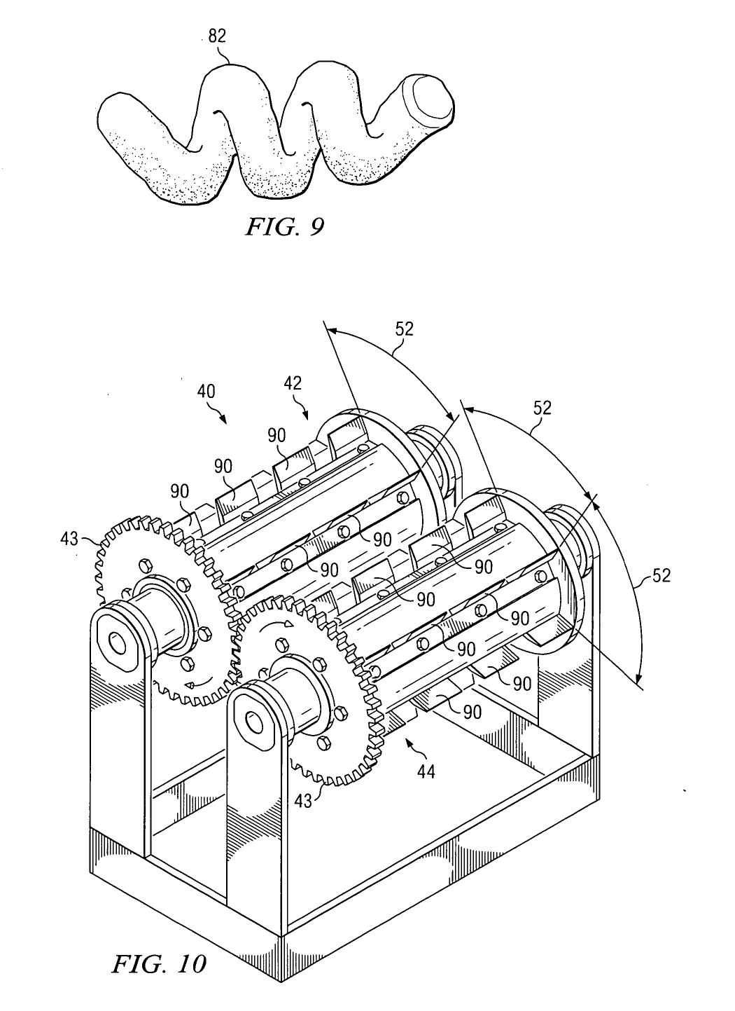

Because the first plurality of blades 46 are offset with respect to the second plurality of blades 48, first blades 46 do not contact second blades 48 tip-to-tip. Thus, the curly puff extrudate 20 is not cut by a pinching action between the tips of the blades, but rather, is cut by a shearing action as it passes through the blade gap 55. Individual extrudate pieces 82 cut with the embodiment of the cutting assembly 40 as illustrated and described above have smooth ends and are of a length as dictated by the blade spacing distance 52, the rotation speed of the rolls, and the feed speed of the conveyor. An example of an individual extrudate piece 82 that may be cut by the cutting assembly 40 is illustrated in FIG. 9.

As illustrated in FIG. 9, the individual extrudate pieces 82 cut from the extrudate 20 have smooth ends. Individual extrudate piece 82 can be cut with more or less coils than that illustrated in FIG. 9. In addition, although the cutting assembly 40 is illustrated and described herein with only a single extrudate, the cutting assembly 40 could cut multiple lines of extrudate. Continuous blades 46 and 48 are preferred for cutting multiple lines of extrudate, however other types of blades could be used.

For example, FIG. 10 illustrates another embodiment of the blades of the cutting assembly 40. According to this embodiment, a plurality of non-continuous blades 90 are removeably mounted in rows along the length of the first roll 42 and second roll 44, respectively. Again, the term “plurality” as used herein means one or more blades. The number of non-continuous blades 90 mounted in each row on the first roll 42 is the same as the number of non-continuous blades 90 mounted in each row on the second roll 44. Non-continuous blades 90 are characterized by several of the same features as continuous blades 46 and 48, including equal blade spacing distances, a corresponding number of rows of blades on each roll, orthogonal orientation of the blades with respect to the wheels on which they are mounted, and offset mounting of the blades.

In particular, there is a one-to-one correspondence between the number of rows of non-continuous blades 90 on the first roll 42 and the number of rows of non-continuous blades 90 on the second roll 44. Moreover, each row of non-continuous blades 90 on first and second rolls 42 and 44 is preferably spaced apart from its adjacent row of non-continuous blades 90 at a blade spacing distance 52 that is slightly greater than the desired length for the cut extrudate piece. As with continuous blades 46 and 48, however, the blade spacing distance 52 can be adjusted to respond to the feed speed of the conveyor and the rotation speed of the rolls, and to control the length of the cut piece of extrudate.

Each of the non-continuous blades 90 is mounted orthogonal to the roll on which it is mounted. Offset mounting of the non-continuous blades 90 is also maintained in this embodiment so that the tips of the blades on roll 42 do not contact the tips of the blades on roll 44 as they rotate past each other. Thus, a blade gap 55 between each blade on the first roll and its corresponding blade on the second roll is maintained. Extrudate to be cut is fed to the cutting assembly in an orthogonal orientation with respect to the blade gap 55, so that the blades 90 contact extrudate in the blade gap orthogonally as they cut it.

Non-continuous blades 90 can be mounted on first roll 42 and second roll 44 respectively by any of several methods known to those of ordinary skill in the art, as long as offset mounting between each blade on the first roll and its corresponding blade on the second roll is maintained. For example, the wedge-screw mounting method described with reference to FIG. 7 can be adapted for use with the non-continuous blades 90 illustrated in FIG. 10. If the wedge-screw mounting method is used, then an individual recess, screw and wedge may be provided for each non-continuous blade 90.

Because the non-continuous blades 90 are mounted in an offset position, the non-continuous blades 90 exert a shearing-type cutting action, as opposed to a pinching-type cutting action, on extrudate within the blade gap 55. As in the embodiment illustrated in FIG. 5, the blade gap 55 is preferably from about 0 inches to about 0.015 inches, and more preferably about 0 inches to about 0.003 inches, but could be greater than either 0.003 or 0.015 inches depending on the shape, texture, moisture content, and rigidity of the extrudate being cut. The preferred ranges for blade gaps when cutting soft extrudates or when cutting rigid extrudates is also as in the embodiment illustrated in FIG. 5. The performance of a cutting assembly with non-continuous blades 90, as well as the end shape and length of individual pieces of the extrudate is also affected by the operating speed of the conveyor, the rotation speed of the rolls, and the speed differential, whether faster or slower, between the two. Accordingly, the ranges of speeds for the conveyor and the rotation of the rolls, as well as the speed differentials are as discussed with reference to the embodiment illustrated in FIG. 5. A broad range of operating speeds can thus be employed on a cutting assembly 40 with non-continuous blades 90, while still producing individual extrudate pieces 82 of a desired length with smooth ends as exemplified in FIG. 9.

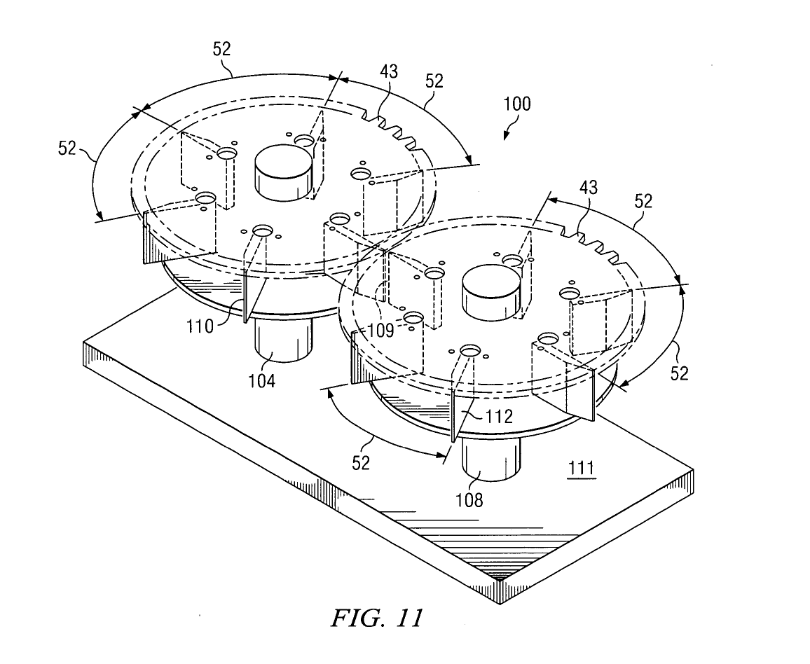

Referring now to FIG. 11, a cutting assembly according to an alternative embodiment of the present invention is illustrated. According to this embodiment, a cutting assembly 100 comprises a first wheel 102 rotatably mounted on a first shaft 104 adjacent to a second wheel 106 rotatably mounted on a second shaft 108. Preferably, first shaft 104 and second shaft 108 are rotatably mounted on a frame 111. Although shown in FIG. 5 as a planar structure, frame 111 can comprise any of a number of structures known in the art as suitable for rotatable mounting of parts such as first and second shafts 104 and 108. First wheel 102 and second wheel 106 are mounted in a horizontal plane. Each of first wheel 102 and second wheel 104 is inwardly curved at its peripheral surface. Thus, when mounted adjacent to each other, a geometrical saddle 109 is formed.

A rotation mechanism causes the first wheel 102 and second wheel 106 to rotate in opposite directions and at the same speed. As with the embodiment of the cutting assembly 40 illustrated in FIG. 5, a motor preferably drives the rotation of the first wheel 102, and a gear assembly 43 transmits rotation to the second wheel 106. According to other embodiments, the second wheel is motorized and drives the rotation of the first wheel. Other rotation mechanisms for causing the first wheel 102 and the second wheel 106 to rotate in opposite directions are known to those of ordinary skill in the art.

A first plurality of wheel blades 110 and a second plurality of wheel blades 112 are removeably mounted at the same blade spacing distance apart on the peripheries of first and second wheels 102 and 106, respectively. As used herein, “plurality” means one or more wheel blades. First and second pluralities of wheel blades 110 and 112 are characterized by several of the same features as the continuous blades 46 and 48 illustrated in FIG. 5, including equal blade spacing distances between each one of the first wheel blades 110 and each one of second wheel blades 112, one-to-one correspondence in the numbers of first wheel blades 110 and second wheel blades 112, orthogonal orientation of the blades with respect to the wheels on which they are mounted and to the extrudate being cut, and offset mounting of the first and second pluralities of wheel blades 110 and 112.

First and second wheel blades 110 and 112 of the cutting assembly 100 can be mounted orthogonally on first wheel 102 and second wheel 106 respectively by any of several methods known to those of ordinary skill in the art, as long as offset mounting between each blade on the first wheel and its corresponding blade on the second wheel is maintained. Since offset mounting of each one of the second plurality of wheel blades 112 with respect to a corresponding one of the first plurality of wheel blades 110 is maintained in cutting assembly 100, the tips of the second wheel blades 112 do not contact the tips of the first wheel blades 110 as they rotate past each other on their respective wheels. Thus, a blade gap 55 between each one of the first plurality of wheel blades 110 and its corresponding one of the second plurality of wheel blades 112 is also maintained. Blade gaps similar to those described with reference to the cutting assembly 40 illustrated in FIG. 5 are also operable for the embodiment of the cutting assembly 100 illustrated in FIG. 11. Also as described with reference to FIG. 5, the preferred range of blade gap 55 for the cutting assembly 100 will be affected by the shape, texture, moisture content, and rigidity of the extrudate being cut.

The diameter of the wheels 102 and 106, the number of blades mounted on the wheels, and the blade spacing distance 52 comprise the “configuration of the cutting assembly”, also referred to as the “cutting assembly configuration”. The cutting assembly configuration is a factor in determining other operating conditions of the cutting assembly, such as the rotation speed for the wheels and the feed speed at which a conveyor provides the extrudate to the cutting assembly.

Preferably, the rotation speed of the first and second wheels 102 and 106 is faster than the feed speed at which a conveyor (not shown) provides the extrudate to be cut to the cutting assembly 100. The preferred speeds for the rotation of the first and second wheels 102 and 106, and the conveyor, are influenced by a number of mechanical and operating conditions such as diameter of the wheels of the cutting assembly, numbers of blades on the wheels, blade spacing distance, driving mechanisms for rotation of the wheels, type and size of conveyor, the amount of meal being pushed through the extruder, and the shape of extrudate being produced. The desired length for the individual piece of extrudate cut by the cutting assembly 100 also influences the preferred speeds for the conveyor and the wheels.

Preferably, the rotation speed of the wheels 102 and 106 is at least 1.1 times greater than the feed speed of the conveyor, and more preferably is in the range from about 1.1 to about 20 times faster than the feed speed of the conveyor. A cutting assembly 100 is operating at a “faster speed differential” when the rotation speed of the wheels is at least 1.1 times greater than the feed speed. Operating a cutting assembly 100 of a given cutting assembly configuration at a faster speed differential results in the cutting of shorter pieces of individual extrudate than when a cutting assembly 100 of the same configuration is operated at a rotation speed less than about 1.1 times the feed speed.

To cut longer pieces of extrudate without changing the configuration of the cutting assembly 100, the first and second wheels 102 and 106 are operated to rotate at a speed equal to or slower than the feed speed of the conveyor. Thus, according to another embodiment, the cutting assembly 100 is operated at a “slower differential speed”, where the rotation speed of the first and second wheels 102 and 106 is less than about 1.1 times the feed speed of the conveyor. When operating at a slower speed differential, the cut pieces of extrudate will be longer than if the speed of rotation of the wheels is greater than about 1.1 times the feed speed of the conveyor operating with a cutting assembly having the same cutting assembly configuration.

According to another method for controlling the length of the cut piece of extrudate, however, the configuration of the cutting assembly 100, in particular, the blade spacing distance 52 is adjusted as described with reference to the embodiment of the cutting assembly 40 illustrated in FIG. 5. Each one of the first plurality of wheel blades 110 is preferably spaced apart from its adjacent first wheel blade at a blade spacing distance 52 that is slightly greater than the desired length for the cut extrudate piece. The blade spacing distance 52 between each one of the second plurality of wheel blades 112 is equal to the blade spacing distance 52 between each of the first wheel blades 110. The number of blades mounted on a wheel, as well as the length of the blade spacing distance, is a function of the diameter (or twice the radius) of the wheel. A maximum and a minimum blade spacing distance 52 would be a function of the diameter of the wheels and the desired length for the cut piece of extrudate.

As with the continuous blades 46 and 48 illustrated in FIG. 5, the blade spacing distance 52 for each blade in the first and second pluralities of wheel blades 82 and 84 has an effect on the length of the individual piece of extrudate cut, and can be adjusted within a wide range for use with any given conveyor feed speed and rotational speed of the wheels and for controlling length of the cut piece of extrudate.

Also as with the embodiment illustrated in FIG. 5, the rotation speed of the wheels and the feed speed of the conveyor for the embodiment illustrated in FIG. 11 are better understood as ratios as opposed to specific values because of variables such as the diameter of the wheels, the number of blades on the wheels, and the blade spacing distance. These variables can accommodate a wide range of adjustments, thus making specific values an unwarranted limitation of the present disclosure.

By way of example, however, the rotation speed of the first and second wheels 102 and 106 is from about 50 RPM (rotations per minute) to about 1000 RPM, and the feed speed of the conveyor is from about 20 FPM to about 750 FPM. As with the embodiment illustrated in FIG. 5, preferred ranges within about 50 RPM to about 1000 RPM and within about 20 FPM to about 750 FPM are again a function of mechanical and operating conditions such as speed of the conveyor supplying extrudate to be cut by the cutting assembly, diameter of the wheels of the cutting assembly, numbers of blades on the wheels, blade spacing distance, driving mechanisms for rotation of the wheels, type and size of conveyor, the amount of meal being pushed through the extruder, and the shape of extrudate being produced. For example, if the shape of the extrudate being produced is a curly puff extrudate, then fast conveyor speeds, for example about 70 FPM or more stretch the extrudate out, resulting in a longer pitch for the coils in the extrudate fed to the cutting assembly. Thus, the extrudate has fewer coils in a given length and resembles a worm-like structure. In contrast, slow conveyor speeds, for example about 50 FPM or less, result in a shorter pitch for the coils, which translates into more coils in a given length.

Thus, it is shown that whether it is desired to cut long pieces of extrudate, or to cut short pieces of extrudate, the appropriate adjustments to the speed differential between the conveyor and the cutting assembly can be made. Likewise, appropriate adjustments to the speed of the conveyor can be made to produce an extrudate with a long or a short pitch. Accordingly, a broad range of operating speeds can be used for the rotation of the first and second wheels 102 and 106 and for the conveyor, with a collateral effect on the pitch and end shape of a curly puff extrudate, as well as the length of an individually cut piece of extrudate. Similarly, the operating speeds of the first and second wheels, and the conveyor, can have collateral effects on the end shape and lengths of extrudates other than curly puff.

In a production system employing the embodiment of the cutting assembly 100 illustrated in FIG. 11, a conveyor provides extrudate to be cut to the cutting assembly 100 as a continuous feed in the same manner as described for the production system illustrated in FIG. 8. The extrudate is conducted from the conveyor through the geometrical saddle 109 and into contact with the first and second pluralities of wheel blades 110 and 112 at the blade gap 55. The extrudate is fed to the cutting assembly orthogonal to the blade gap 55, so that the blades 110 and 112 are orthogonal to the extrudate as they cut it. The first and second wheel blades 110 and 112 cut the extrudate in the blade gap 55 into individual extrudate pieces with a shearing type action. The individual extrudate piece 82 illustrated in FIG. 9 is exemplary of an individual extrudate piece that may be cut by the cutting assembly 100.

The embodiment of the cutting assembly illustrated in FIG. 11 shows the first and second wheels 102 and 106 mounted in a horizontal plane. It is apparent, however, that more than two wheels could be mounted in the horizontal plane. For example, third and fourth, fifth and sixth wheels, etc., could be mounted on individual shafts, with each pair forming its own geometrical saddle 109 and cutting an extrudate fed to it. Moreover, the wheels could also be mounted in a vertical plane, where a plurality of wheels could be also be used.

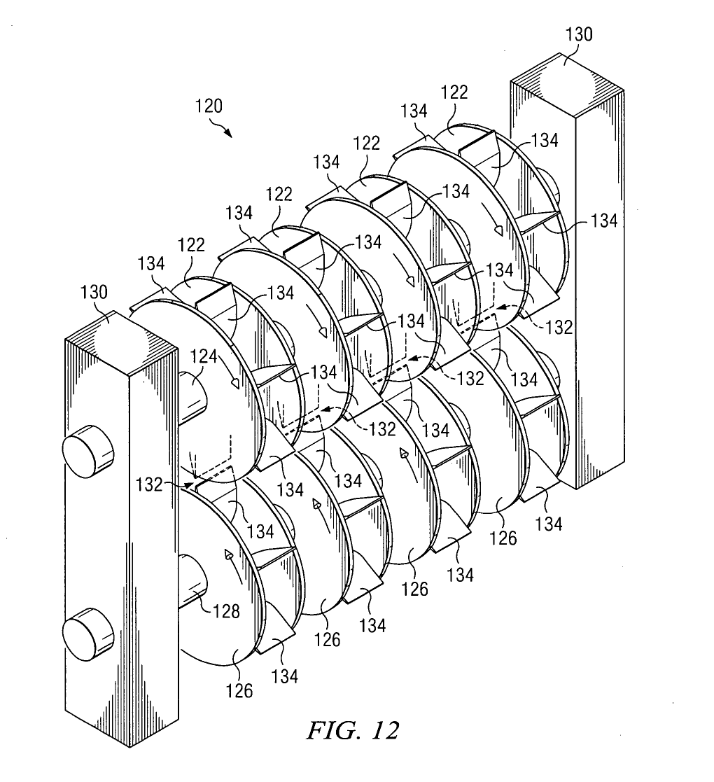

For example, FIG. 12 shows a cutting assembly 120 according to an alternative embodiment of the invention, where bladed wheels similar to those illustrated in FIG. 11 are mounted in a vertical plane. Cutting assembly 120 comprises an upper row of wheels 122 rotatably mounted on an upper shaft 124 in a vertical plane with respect to an adjacent lower row of wheels 126 rotatably mounted on a lower shaft 128. Upper and lower shafts 124 and 128 are supported by a frame 130. Each wheel in the upper and lower rows of wheels 122 and 126 is inwardly curved at its peripheral surface. Thus, when mounted adjacent to each other in a vertical plane, a conduction saddle 132 is formed there between.

Cutting assembly 120 illustrated in FIG. 12 is characterized by many of the same features as cutting assembly 100 illustrated in FIG. 11, such as the opposite directions of rotation of the wheels, ranges of conveyor speed, rotation speed, speed differential, blade spacing distance, blade gap, and methods for offset mounting of the blades. Generally, cutting assembly 120 illustrated in FIG. 12 comprises the cutting assembly 100 illustrated in FIG. 11, with the major difference being that a plurality of wheels are mounted in rows in a vertical plane as opposed to a horizontal plane.

Particularly, the upper row of wheels 122 rotates in a direction opposite that of the lower roll of wheels 126. The rotation of the upper and lower rolls of wheels 122 and 126 may be driven as described with reference to the embodiment of the cutting assembly 100 illustrated in FIG. 11. Furthermore, the upper row of wheels 122 and the lower row of wheels 126 rotate at the same speed. The preferred rotation speed of the upper and lower rows of wheels 126 is as described with reference to the cutting assembly 100 illustrated in FIG. 11. Thus, the upper and lower wheels 122 and 126 preferably rotate at a speed that is faster than the speed at which a conveyor (not shown) provides the extrudate to be cut to the cutting assembly 120.

However, as was the case with the cutting assembly 100 illustrated in FIG. 11, the preferred speeds for the rotation of the upper and lower rows of wheels 122 and 126 and the conveyor are influenced by variables such as the type and size of the conveyor, driving mechanisms for rotation of the wheels, and the desired length for the individual piece of extrudate cut by the cutting assembly 120. Moreover, the speed of rotation could be equal to or slower than the feed speed of a conveyor supplying extrudate to be cut, with the previously discussed collateral effects on the performance of the cutting assembly 120 and on the end shape of the cut extrudate for both curly puff extrudates and extrudates other than curly puff.

Referring still to the cutting assembly 120 illustrated in FIG. 12, blades 134 are mounted on each wheel in the upper and lower rows of wheels 122 and 126 in an offset position as described with reference to the cutting assemblies 40 and 100 illustrated in FIGS. 5 and 11. Also as described with reference to FIGS. 5 and 11, the blades 134 are mounted so that they are orthogonal to the extrudate as they cut it. In particular, cutting assembly 120 comprises the cutting assembly 100, with the major difference being that a plurality of wheels are mounted in rows in a vertical plane as opposed to a horizontal plane. Thus, blades 134 are mounted orthogonal to their respective wheels and offset with respect to each other, so that a blade gap 55 exists between each blade on the upper row of wheels 122 and its corresponding blade on the lower row of wheels 126 as the blades 134 rotate past each other.

As discussed with reference to the cutting assembly 100 in FIG. 11, each blade 134 mounted on each wheel in the upper and lower rows of wheels 122 and 126 is mounted at an adjustable blade spacing distance 52 from its adjacent blade. Methods for mounting the blades 134 on the first and second wheels are the same as for cutting assembly 100, and thus are not repeated herein. As previously discussed, adjusting the blade spacing distance provides a method for controlling the length of the individual cut piece of extrudate.

Cutting assembly 120 is capable of cutting as many lines of extrudate as it has conduction saddles 132. Thus, in a production system employing the embodiment of the cutting assembly 120 illustrated in FIG. 12, a conveyor provides one or more lines of extrudate to the cutting assembly 120 as a continuous feed in the same manner as described for the production system illustrated in FIG. 8. The lines of extrudate are conducted from the conveyor through the conduction saddles 132 and into contact with the blades 134 at the blade gap 55. The blades 134 exert a shearing-type cutting action on the extrudate to cut it into individual extrudate pieces 82 as exemplified in FIG. 9.

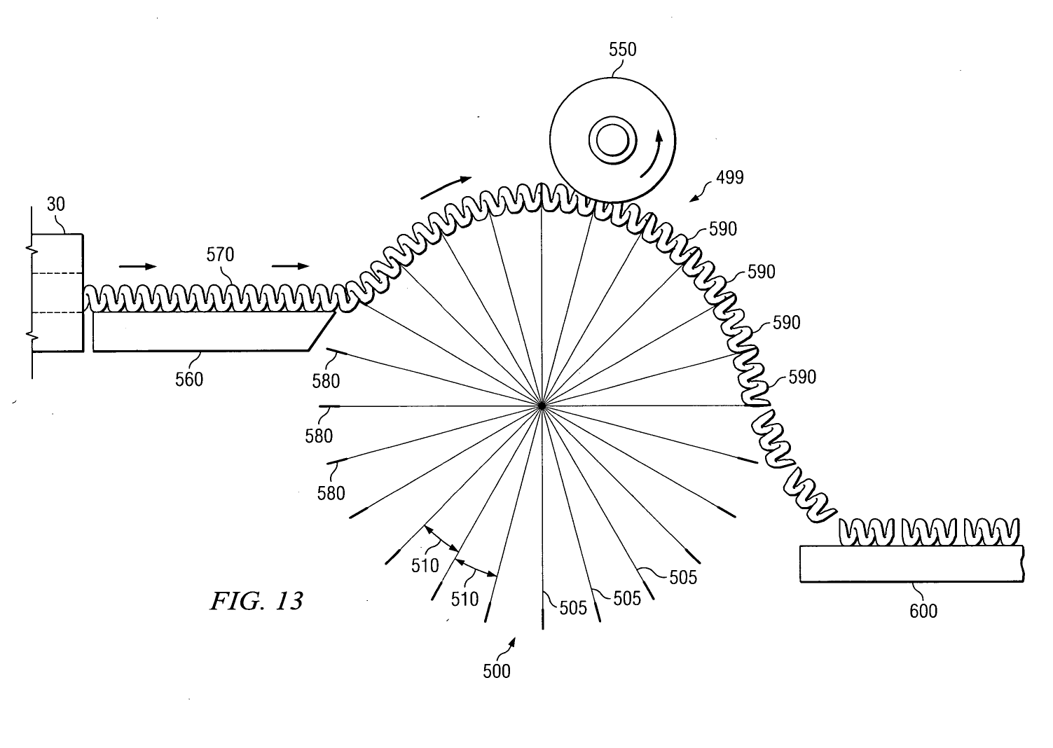

Referring now to FIG. 13, an embodiment of another cutting assembly is illustrated. According to this embodiment, the cutting assembly 499 comprises a rotatable flighted wheel 500 with flights 505 spaced a uniform distance 510 apart. The cutting assembly 499 further comprises a rotatable smooth wheel 550. The smooth wheel 550 does not have any blades and rotates in a direction opposite to the flighted wheel 500, but at the same speed as the flighted wheel. The rotation of the flighted wheel 500 is driven by a motor (not shown). A gear disposed on the flighted wheel 500 transmits rotation to the smooth wheel 550. Smooth wheel 50 and may be spring-loaded to assist with its rotation.

In a production system employing the cutting assembly 499 illustrated in FIG. 13, the extrudate 570 exits the forming tube 30 onto an input conveyor 560. Input conveyor 560 provides the extrudate 570 as a continuous feed to the flighted wheel 500, which is driven at a speed equivalent to the speed of the input conveyor 560. The extrudate 570 is conveyed over the flighted wheel 500 as it rotates. As it is conveyed, the extrudate drops a given number of coils into the uniform distance 510 between each flight 505.

As the flighted wheel 500 continues to rotate, the edge 580 of each flight 505 is brought into contact with the smooth wheel 550. Each contact between the flight edge 580 and the smooth wheel 550 cuts the extrudate, resulting in individual extrudate pieces 590 having the given number of coils that dropped into the uniform distance 510 between each blade flight 505. The individual extrudate pieces 590 continue to rotate on the flighted wheel 500 until a point at which gravity forces them off of the flighted wheel 500, and they fall onto an output conveyor 600. From output conveyor 600, the extrudate pieces 590 can be sent for further processing. Examples of such processing include, but are not limited to, seasoning, baking, frying, and packaging the individual extrudate pieces 590.

According to another embodiment not illustrated with a figure herein, the flighted wheel 500 is replaced by a flighted conveyor. If a flighted conveyor is used, the smooth wheel 550 is positioned above the flighted conveyor, and rotates in a direction opposite the direction of linear movement of the flighted conveyor. The extrudate is cut at the point of contact between the flight edges of the conveyor and the smooth wheel. Whether the embodiment comprising a flighted wheel or the embodiment comprising the flighted conveyor is used, the speed of rotation, feed speed, and distance between the flights can be adjusted to affect the shape of the extrudate and the length of the individual piece of cut extrudate.

While the present invention is disclosed in reference to curly puff extrudates, it should be understood that the present invention could be employed with cylindrical extrudates, uniquely shaped extrudates such as star, cactus, or pepper shaped, or any other shape of extrudate, such as sinusoidal, rectangular, triangular, or other non-circular cross-sectional area.

It should further be understood that any number of various types of extruders could be used with the invention, including twin screw and single screw extruders of any length and operating at a wide range of rotational speeds.

Further, while the process has been described with regard to a corn-based product, it should be understood that the invention can be used with any puff extrudate, including products based primarily on wheat, rice, or other typical protein sources or mixes thereof. In fact, the invention could have applications in any field involving extrusion of a material that quickly goes through a glass transition stage after being extruded through a die orifice.

While the invention has been particularly shown and described with reference to a preferred embodiment, it will be understood by those skilled in the art that various changes in form and detail may be made therein without departing from the spirit and scope of the invention.

1. A cutting assembly for cutting an extrudate comprising:
a frame;
a first roll disposed in a plane and rotatably mounted on said frame;
a second roll disposed in the plane and adjacent to said first roll, said second roll being rotatably mounted on said frame;
a first plurality of blades mounted along the length of said first roll; and
a second plurality of blades mounted along the length of said second roll and offset with respect to said first plurality of blades.

2. The cutting assembly of claim 1 further comprising:
a rotation mechanism causing said first roll and said second roll to rotate in opposite directions; and
a blade gap between each of said first plurality of blades and a corresponding one of said second plurality of blades, which is created as said first and second pluralities of blades rotate past each other on said first and second rolls respectively.

3. The cutting assembly of claim 2 wherein said blade gap is from about 0 inches to about 0.015 inches.

4. The cutting assembly of claim 3 wherein said blade gap is from about 0 inches to about 0.003 inches.

5. The cutting assembly of claim 1 wherein said first and said second pluralities of blades are mounted orthogonal to the first and second rolls respectively.

6. The cutting assembly of claim 1 wherein each of said first plurality of blades is mounted on said first roll at a blade spacing distance apart, and each of said second plurality of blades is mounted on said second roll at the same blade spacing distance apart.

7. The cutting assembly of claim 1 wherein said first and said second pluralities of blades are removeably mounted on said first and said second rolls respectively.

8. The cutting assembly of claim 7 further comprising:
a first plurality of recesses formed along the length of said first roll;
a second plurality of recesses formed along the length of said second roll; and
a wedge positioned in each of said first and second pluralities of recesses and filling substantially all of said recesses, wherein said first and said second pluralities of blades are inserted into the unfilled portions of said first and said second pluralities of recesses respectively.

9. The cutting assembly of claim 1 wherein said second plurality of blades is equal in number to said first plurality of blades.

10. The cutting assembly of claim 1 wherein said first plurality and said second plurality of blades comprise continuous blades.

11. The cutting assembly of claim 1 wherein said first plurality and said second plurality of blades comprise non-continuous blades.

12. The cutting assembly of claim 11 wherein said non-continuous blades are mounted in a number of rows along the length of said first roll and an equal number of rows along the length of said second roll.

13. The cutting assembly of claim 12 wherein the number of non-continuous blades in each row along said first roll is equal to the number of non-continuous blades in each row along said second roll.

14. A cutting assembly for cutting an extrudate comprising:
a first wheel disposed in a plane and rotatably mounted on a first shaft, said first wheel having an inwardly curved peripheral surface;
a second wheel disposed in the plane and adjacent to said first wheel, said second wheel being rotatably mounted on a second shaft and having an inwardly curved peripheral surface;
a saddle formed between the peripheral surface of said first wheel and the peripheral surface of said second wheel;
a first plurality of wheel blades mounted on said first wheel orthogonal to said first wheel; and
a second plurality of wheel blades mounted on said second wheel orthogonal to said second wheel and in an offset position with respect to said first plurality of wheel blades.

15. The cutting assembly of claim 14 further comprising:
a rotation mechanism causing said first wheel and said second wheel to rotate in opposite directions; and
a blade gap between each of said first plurality of wheel blades and a corresponding one of said second plurality of wheel blades, which is created as said first and second pluralities of wheel blades rotate past each other on said first and second wheels respectively.

16. The cutting assembly of claim 15 wherein said blade gap is from about 0 inches to about 0.015 inches.

17. The cutting assembly of claim 16 wherein said blade gap is from about 0 inches to about 0.003 inches.

18. A cutting assembly according to claim 14 wherein each one of said first plurality of wheel blades is mounted on said first wheel at a blade spacing distance apart from its adjacent one of said first wheel blades; and
each one of said second wheel blades is mounted on said second wheel at the same blade spacing distance from its adjacent one of said second wheel blades.

19. The cutting assembly of claim 14 wherein said second plurality of wheel blades is equal in number to said first plurality of wheel blades.

20. The cutting assembly according to claim 14 further comprising:
a third wheel disposed in the plane and adjacent to said second wheel, said third wheel being rotatably mounted on a third shaft and having an inwardly curved peripheral surface;
a fourth wheel disposed in the plane and adjacent to said third wheel, said fourth wheel being rotatably mounted on a fourth shaft and having an inwardly curved peripheral surface;
a geometrical saddle formed between the peripheral surface of said third wheel and the peripheral surface of said fourth wheel;
a third plurality of wheel blades mounted on said third wheel orthogonal to said third wheel; and
a fourth plurality of wheel blades mounted on said fourth wheel orthogonal to said fourth wheel and in an offset position with respect to said third plurality of wheel blades.

21. A cutting assembly according to claim 14 wherein said plane is a horizontal plane.

22. A cutting assembly according to claim 14 wherein said plane is a vertical plane.

23. A cutting assembly comprising:
an upper row of wheels formed by a plurality of first wheels rotatably mounted on the first shaft, each of said plurality of wheels having an inwardly curved peripheral surface;
a lower row of wheels formed by a plurality of second wheels rotatably mounted on the second shaft and disposed adjacent to said upper row of wheels and in a vertical plane with respect to said upper row of wheels;
a plurality of conduction saddles formed between the peripheral surface of each first wheel in said upper row of wheels and the peripheral surface of each second wheel in said lower row wheels;
a first plurality of wheel blades mounted on each first wheel in said upper row of wheels and orthogonal to the wheel;
a second plurality of wheel blades mounted on each second wheel in said lower row of wheels and orthogonal to the wheel, each of said second plurality of wheel blades being mounted in an offset position with respect to a corresponding one of said first plurality of wheel blades.

24. A production system for producing individual pieces of extrudate comprising:
a conveyor positioned to feed extrudate to a cutting assembly at a continuous feed speed;
a cutting assembly positioned to receive the extrudate from said conveyor and cut the extrudate into individual pieces, said cutting assembly having a first roll with a plurality of first blades mounted thereon in an offset position with respect to a corresponding plurality of second blades mounted on a second roll;
a piece conveyor positioned to receive individual pieces of extrudate from said cutting assembly and convey the individual pieces of extrudate for processing.

25. A production system according to claim 24 wherein said conveyor has an input and an output end, at least one of which is height adjustable.

26. A production system according to claim 24 further comprising:
a chute positioned between said conveyor and said cutting assembly.

27. A production system according to claim 24 wherein said cutting assembly further comprises a lever mechanism to adjust the cutting assembly for receiving the extrudate from said conveyor.

28. A production system according to claim 24 further comprising a docking assembly positioned between said cutting assembly and said conveyor to provide a physical connection there between.

29. A method for cutting an extrudate comprising:
rotating a first roll of a cutting assembly and a second roll of a cutting assembly in opposite directions and at a rotation speed, said first roll having a first plurality of blades mounted thereon at a blade spacing distance apart and said second roll having a second plurality of blades each mounted thereon at the same blade spacing distance apart;
forming a blade gap between each of the first plurality of blades and a corresponding one of the second plurality of blades as the first plurality of blades rotate past the second plurality of blades;
feeding the extrudate to the cutting assembly at a feed speed; and
cutting the extrudate into individual pieces of extrudate with a shearing type cutting action by contacting the extrudate fed to the cutting assembly with one of the first plurality of blades and a corresponding one of the second plurality of blades when the extrudate enters the blade gap.

30. A method according to claim 29 further comprising:
rotating the first roll and the second roll at a rotation speed greater than the feed speed.

31. A method according to claim 30 further comprising:
rotating the first roll and the second roll at a rotation speed greater than about 1.1 times the feed speed.

32. A method according to claim 31 further comprising:
rotating the first roll and the second roll at a rotation speed about 1.1 to about 20 times greater than the feed speed.

33. The method according to claim 29 further comprising:
rotating the first roll and the second roll at a rotation speed less than the feed speed.

34. The method according to claim 33 further comprising:
rotating the first roll and the second roll at a rotation speed less than about 1.1 times the feed speed.

35. The method according to claim 29 further comprising:
feeding the extrudate at a feed speed from about 20 feet per minute to about 750 feet per minute; and
rotating the first roll and the second roll at a rotation speed from about 50 rotations per minute to about 1000 rotations per minute.

36. The method according to claim 35 further comprising:
feeding the extrudate at a feed speed from about 300 feet per minute to about 500 feet per minute; and
rotating the first roll and the second roll at a rotation speed from about 300 rotations per minute to about 500 rotations per minute.

37. The method according to claim 29 further comprising:
feeding the extrudate at a feed speed from about 100 to about 140 feet per minute; and
rotating the first roll and the second roll at a rotation speed from about 110 to about 170 feet per minute.

38. The method according to claim 29 further comprising:
adjusting the blade gap to cut the extrudate being fed to the cutting assembly.

39. The method according to claim 29 further comprising:
adjusting the feed speed to cut the extrudate being fed to the cutting assembly.

40. The method according to claim 29 further comprising:
adjusting the blade spacing distance to control the length of the individual piece of extrudate.

41. The method according to claim 29 further comprising:
adjusting at least one of the rotation speed of the first and the second roll and the feed speed of the extrudate to control the length of the individual pieces of cut extrudate.

42. The method according to claim 29 wherein said cutting the extrudate into individual pieces of extrudate further comprises:
orthogonally contacting the extrudate in the blade gap with one of the first plurality of blades and a corresponding one of the second plurality of blades.
